(19) United States
(12) Patent Application Publication
(10) Pub. No.: US 2005/0053452 A1
(43) Pub. Date: Mar. 10, 2005

(54) Non-linear reciprocating packing mechanism for refuse collection vehicle

(76) Inventor: Gabe Tomassoni, Bracebridge (CA)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/934,224

(22) Filed: Sep. 3, 2004

(30) Foreign Application Priority Data
Sep. 5, 2003 (CA) 2,439,861

(51) Int. Cl. B60P 1/00

(52) U.S. Cl. 414/525.5

(57) ABSTRACT

The present invention relates to a refuse collection system for use in combination with a transport vehicle. The refuse collection system has a housing with a collection hopper and a storage area and an opening to the collection hopper. The refuse collection system also has a packer that is movable upon curved channels front and rearwards within the housing. The packer is movable upon a generally arcuate path from a rest position at a first end of the collection hopper to a deposit position at a second end of the collection hopper proximate to the storage area. Guide shoes may be attached to the packer and engage with the curved channels so as to determine the path of movement of the packer such that the packer sweeps refuse from the collection hopper into the storage area.

### FIELD OF THE INVENTION

The present invention relates to a packing mechanism for use in association with a vehicle that collects, compacts, stores and transports refuse.

### BACKGROUND OF THE INVENTION

Side-loading refuse vehicles are well known in the art. Generally, such vehicles have a housing comprising a hopper region into which waste is deposited. The refuse is then transferred to a storage area within the housing where the refuse is compacted, to varying degrees, in order to maximize the capacity of the storage area, and thus the functional operating area of the vehicle. Once the storage area has reached its capacity, the refuse is ejected from the storage area by tilting the housing upwards or by the displacement of the refuse using a compacting blade or similar mechanism.

Packing mechanisms for such vehicles are also taught in a variety of forms in the art. Examples of side-loading refuse vehicles include U.S. Pat. No. 2,750,055 (Huffines) and U.S. Pat. No. 2,961,105 (Shubin). Huffines discloses a compressor mechanism and compressor blade to move refuse to a storage compartment, while Shubin discloses a loading piston which performs the same function.

U.S. Pat. No. 4,096,956 (Gaskin) discloses a curved pusher blade, which pushes the refuse onto an inclined planar member which then pivots so as to position the refuse before a compaction blade in the storage area. As a result, refuse at the forward end of the storage area is not drawn back into the receiving area by the retraction of the compaction blade.

U.S. Pat. No. 4,260,316 (Gollnick) discloses a configuration where a hopper plate pivots about its attachment to the side of the vehicle. This transfers refuse out of the hopper into the path of a sweep panel, which in turn forces the refuse into a storage body. A packer plate then compacts the refuse within the body. This device is complicated, having a multiplicity of moving parts, and must be operated in a two-stage cycle. Furthermore, the packer plate is subject to strain since it does not span the entire width of the storage body and this also results in uneven compacting of the refuse. Finally, while the sweep panel and the packer plate are in operation, the loading opening must be closed, which compromises the safety of the operator.

U.S. Pat. No. 4,892,454 (Behling et al.) attempts to enhance the compaction capacity of the vehicle by adding a counter pressure plate that applies force opposite to a pressure plate, thus trapping the stored refuse between the two plates while compacting it.

U.S. Pat. No. 6,146,078 (Hamill et al.) discloses a packer blade that is extendible along the entire length of the storage compartment. Accordingly, an operator can add new refuse to the hopper before the packer blade has completed its refuse compaction cycle. Furthermore, a single stage hydraulic cylinder is used to achieve such extension. Channels along the length of the storage compartment, into which guides on the compactor blade and ejector mechanism fit, are necessary to ensure that the blade moves evenly. A drawback of this configuration is the likelihood of refuse blocking the channels, and thus also blocking the movement of the blade.

U.S. Pat. No. 6,250,873 (Stragier) discloses a means for ejecting and packing. Specifically, a hydraulic drive assembly is simultaneously actuated with the extension of an extendible element. Thus, during the movement of the refuse toward the storage body, the speed of the compacting plate decreases while the force exerted by the plate increases.

Finally, co-pending Canadian patent application Serial No. 2,413,470 (Tomassoni) discloses a container for use in association with a refuse transport vehicle, which container has a packing arm attached near the top of the container which is movable along an arcuate path to move refuse from the hopper to the storage area. The attachment of the packer blade at or near the top wall of the container prevents the introduction of other components to the design of the refuse container.

There are a number of limitations associated with prior art refuse collection and transport vehicles. The main drawback with these vehicles is that they disclose complicated compacting mechanisms with many moving parts. This makes such vehicles prone to failure, expensive to maintain and slow to operate. Furthermore, many of the prior art vehicles disclose packing mechanisms with components that do not minimize the friction between the packing mechanism and the tracks that govern its movement. Finally, efficient compacting of refuse is difficult to achieve using prior art vehicles since traditional compacting mechanisms do not compact to a uniform density and thus the storage capacity of the collection vehicle is not optimized.

### SUMMARY OF THE INVENTION

An object of the invention is to provide a container for use in association with a vehicle, for collecting, compacting, storing and transporting refuse.

A further object of the invention is to provide a container for use in association with a vehicle that compacts waste efficiently while minimizing wear upon the packer.

A further object of the invention is to provide a container for use in association with a vehicle in which the packer blade is orientated to maximize the volume of the hopper so as to minimize the number of cycles required to transfer refuse from the hopper.

A further object of the invention is to provide a container for use in association with a vehicle, which container has a configuration that maximizes the volume of waste within the storage area by compacting waste such that it has a uniform density throughout the storage area.

A further object of the invention is to provide a container for use in association with a vehicle which container has a packer that moves in an arcuate path through the hopper but which is not attached at or near the top wall of the hopper.

A further object of the invention is to provide a container for use in association with a vehicle which container has a packer that is orientated so as to have greater penetration into the storage area.

A further object of the invention is to provide a container for use in association with a vehicle which can be used for single stream refuse collection or for multiple stream refuse collection where different types of refuse are separated within the collection hopper and storage area of the container.

A further object of the invention is to provide a container for use in association with a vehicle in which the need for a follower and other unnecessary moving parts is eliminated, thus minimizing the number of moving components in the compacting mechanism so as to limit the cost and necessity for maintenance of the vehicle while increasing its cycle speed.

Accordingly, the invention herein comprises a refuse collection system for use in combination with a transport vehicle. The refuse collection system has a housing with a collection hopper at a first end and a storage area at a second end. The collection hopper also has first and second sides. The collection hopper also has an opening in at least one of the first side or the second side of the collection hopper and curved channels on each of the first side and the second side of the collection hopper. The refuse collection system also has a packer that is movable frontwards and rearwards within the housing, which packer has a blade portion. The packer is movable upon a generally arcuate path defined by the curved channels from a rest position at a first end of the collection hopper to a deposit position at a second end of the collection hopper proximate to the storage area such that the blade portion passes over the collection hopper to sweep refuse from the collection hopper into the storage area. The packer may have guide shoes attached which engage with the curved channels so as to determine the path of movement of the packer.

### BRIEF DESCRIPTION OF THE DRAWINGS

In drawings which illustrate by way of example only a preferred embodiment of the invention:

FIG. 1 is a side plan view of the container attached to a refuse collection vehicle in which the housing has been partially cut away so as to show the packer;

FIG. 2 is a side plan view of the collection hopper of a refuse collection vehicle in which the housing has been partially cut away and the packer has been removed;

FIG. 3 is a side plan view of the collection hopper of the vehicle for collecting waste in which the housing has been partially cut away so as to show the packer in a rest position;

FIG. 4 is a side plan view of the collection hopper of the vehicle for collecting waste in which the housing has been partially cut away so as to show the packer in a deposit position;

FIG. 5 is front plan view of the packer;

FIG. 6 is a side plan view of a guide shoe attached to the packer;

FIG. 7 is a cross-sectional view of the guide shoe attached to the packer and engaged with the guide channel, taken along line 7-7 of FIG. 3;

FIG. 8 is a cross-sectional view of the guide rollers attached to the packer and engaged with the guide roller track, taken along line 8-8 of FIG. 3;

FIG. 9 is a top plan view of a dual hydraulic press mechanism attached to the packer in the rest position and in the deposit position;

FIG. 10 is a side plan view of the hopper of a refuse collection vehicle showing two alternative paths of guide roller tracks and guide shoe channels;

FIG. 11a is a side plan view of a further embodiment of the packer within the hopper; and

FIG. 11b is a cross-sectional view of the packer extension within the envelope, taken along line 11b-11b of FIG. 11a.

While the invention will be described in conjunction with the illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENTS

In the following description, similar features in the drawings have been given similar reference numerals.

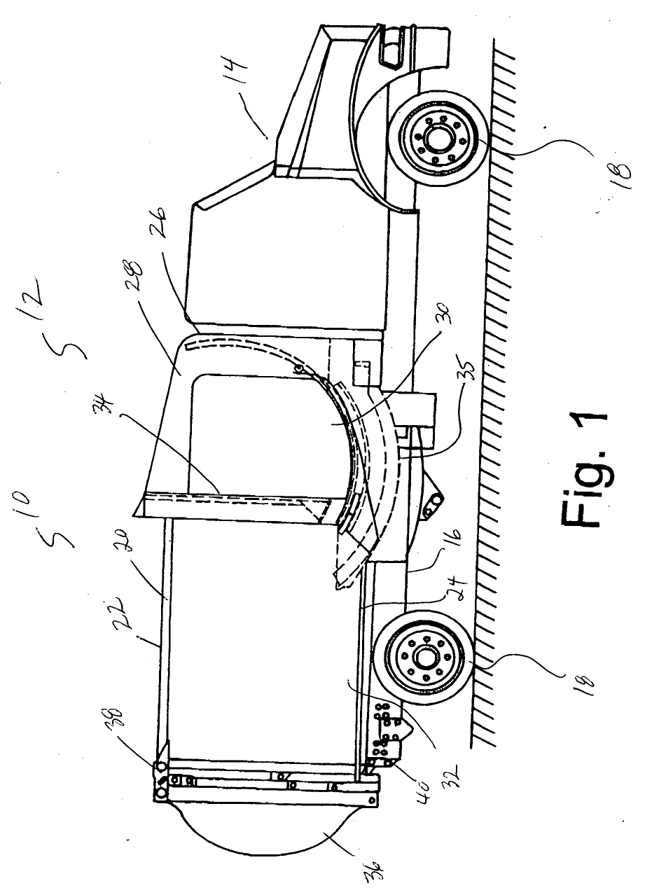

A container 10 for collecting, compacting and storing refuse, for use in association with a vehicle 12, having a cab 14, chassis 16 and wheels 18 is shown in FIG. 1. A housing 20 comprising a top wall 22, a floor portion 24, a front wall 26, a first side wall 28 and a second side wall (not shown) is mounted on the chassis 16 of the vehicle 12. The housing 20 is divided into a hopper 30 and a storage area 32, which are separated by a divider 34. The floor portion 35 of hopper 30 is curved. A door 36 is pivotably attached to the housing 20 proximate to the storage area 32 by a pivoting attachment means 38. The container for collecting, compacting and storing refuse 10 is attached to the vehicle 12 by an attachment means 40.

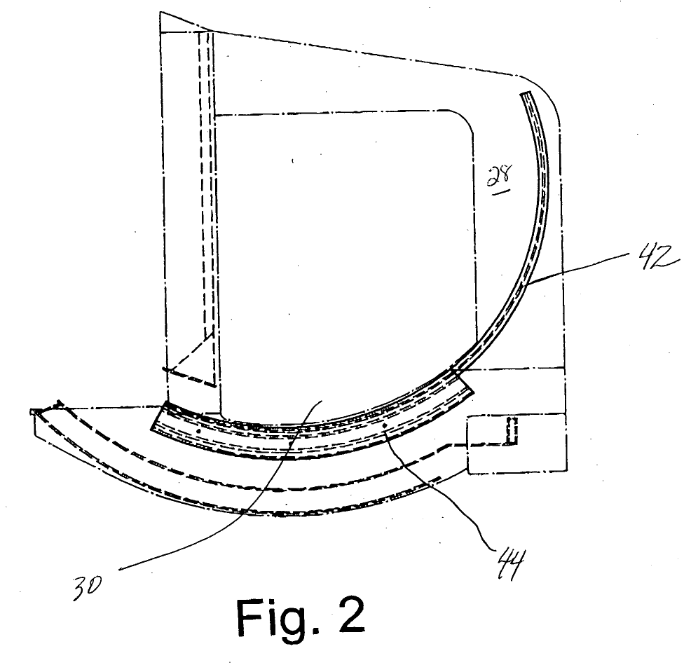

The hopper 30 is shown in greater detail in FIGS. 2 to 4. Guide roller track 42 is attached to the first side wall 28 and is shaped so as to preferably form an arc. Guide shoe channel 44 is also contiguous to first side wall 28 and is also shaped to form an arc, the curvature of which is the same as the curvature of the arc formed by guide roller track 42. Guide roller track 42 extends such that for a portion of its length it is above guide shoe channel and forms the top wall of guide shoe channel 44. It will be understood by those skilled in the art that the second side wall (not shown) will also have a guide roller track and guide shoe channel, which are shaped so as to form mirror images of guide roller track 42 and guide shoe channel 44 on the second side wall.

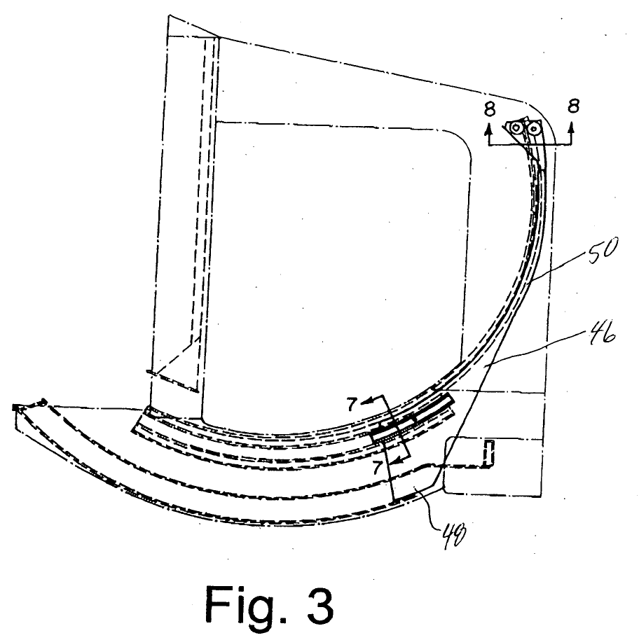

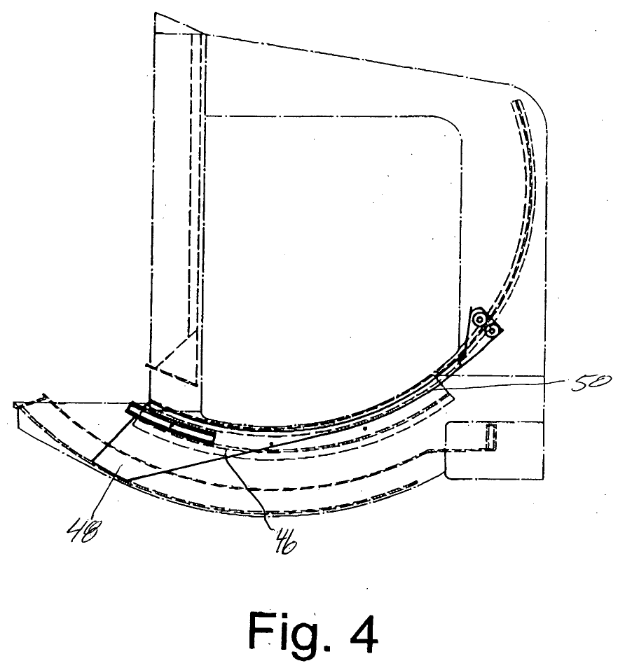

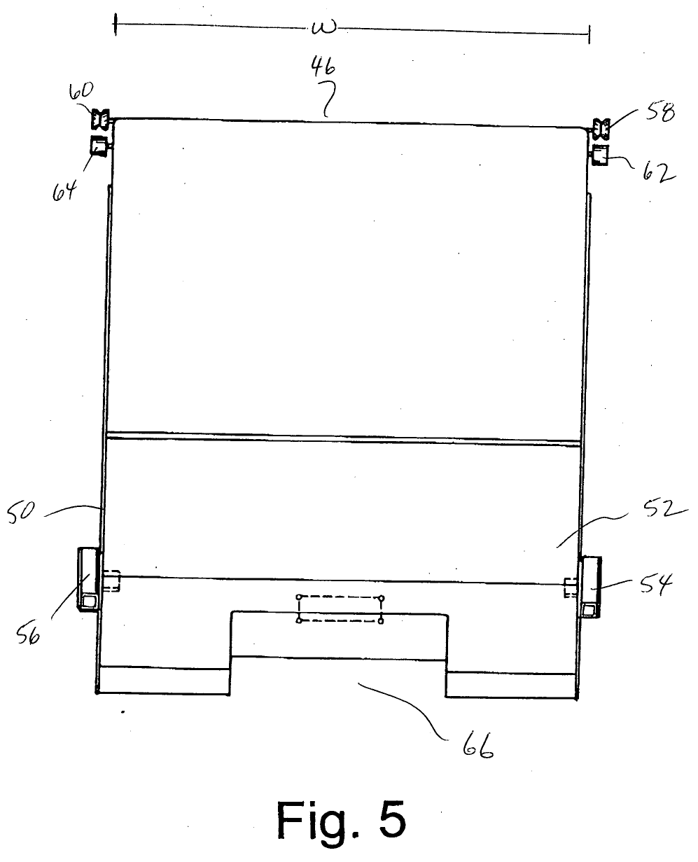

A packer 46 in the hopper 30 is shown in FIGS. 3 and 4. The packer 46 is moveable between a rest position as shown in FIG. 3 and a deposit position as shown in FIG. 4. The packer 46 is shown in greater detail in FIG. 5.

The packer 46 has a blade portion 48 and a shield portion 50. The width w of the packer 46 is slightly less than the distance between the first side wall 28 and the second side wall (not shown). The packer 34 has a leading face 52 which impacts refuse within the hopper 30.

Guide shoes 54 and 56 may also be attached to the blade portion 48. The guide shoes 54 and 56 are curved to fit within the guide shoe channel 44 (and its counterpart on the opposite facing wall) when the packer 46 is in position in the hopper 10. Tapered guide rollers 58 and 60 and flat guide rollers 62 and 64 are attached to the shield portion 50 and are engaged with the guide roller track 42 and its counterpart (not shown). The packer 34 also defines cavity 66 to account for the drive shaft (not shown) of vehicle 12.

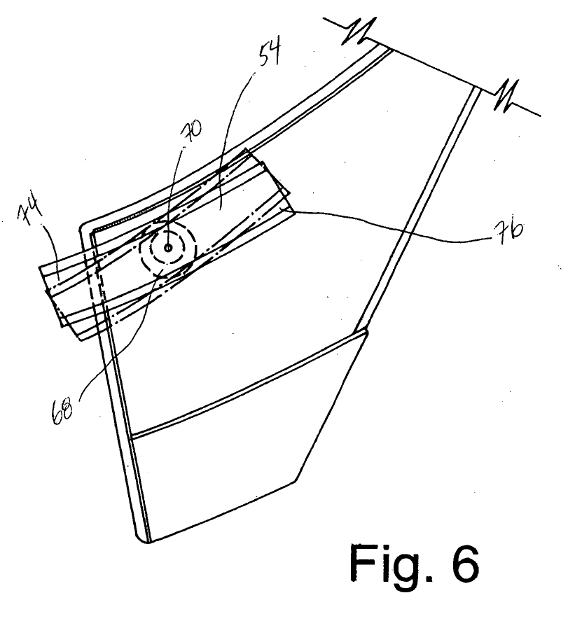

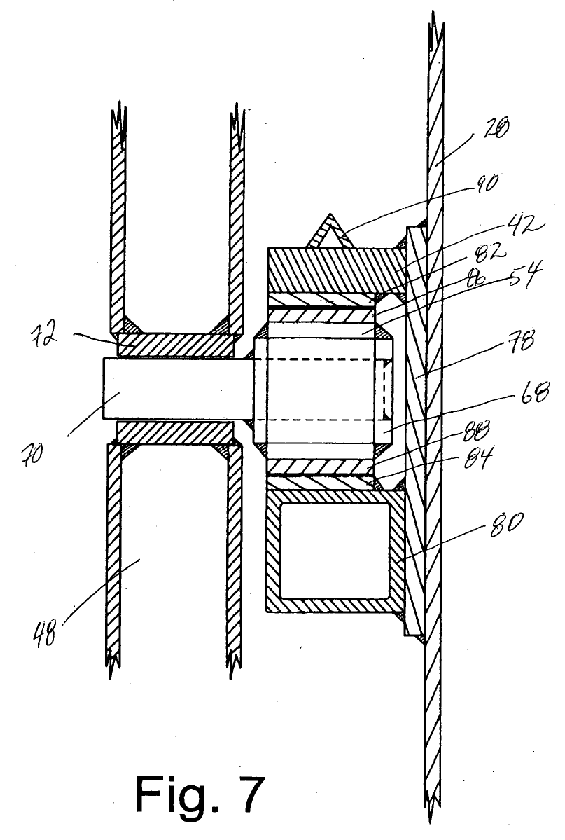

The guide shoe 54 rests upon a member 68 which is attached to the blade portion 48 of the packer 46 by a pin 70, as shown in FIGS. 6 and 7. The member 68 is pivotable about the pin 70, thus also rotating the attached guide shoe 54 to positions such as those depicted by the stippled lines in FIG. 6. The pin 70 is engaged within a pivot block 72 within the packer 46 and is rotatable therein. The guide shoe 54 may be tapered such that its first end 74 is taller than its second end 76. It will be understood by those skilled in the art that a similar guide shoe 56 is similarly attached to the opposite side of the packer 46 and may be similarly tapered.

The guide shoe channel 44 is formed by a side plate 78, the guide roller track 42 and a bottom plate 80. The side plate 78 is attached to the side wall 28 and each of the guide roller track 42 and the bottom plate 80 are attached to the side plate 78. Guide channel wear bars 82 and 84 are attached to guide roller track 42 and bottom plate 80 respectively and guide shoe wear bars 86 and 88 may be attached to the upper face and the lower face respectively of guide shoe 54. The wear bars 82, 84, 86 and 88 are replaceable and may be comprised of a high density material such as a nickel chromium alloy. A peak 90 is attached to the top surface of the guide roller track 42. It will be understood by those skilled in the art that guide shoe 56 is engaged within a guide shoe channel (not shown) on the second side wall of the housing 20, which guide shoe channel is constructed as described within this paragraph.

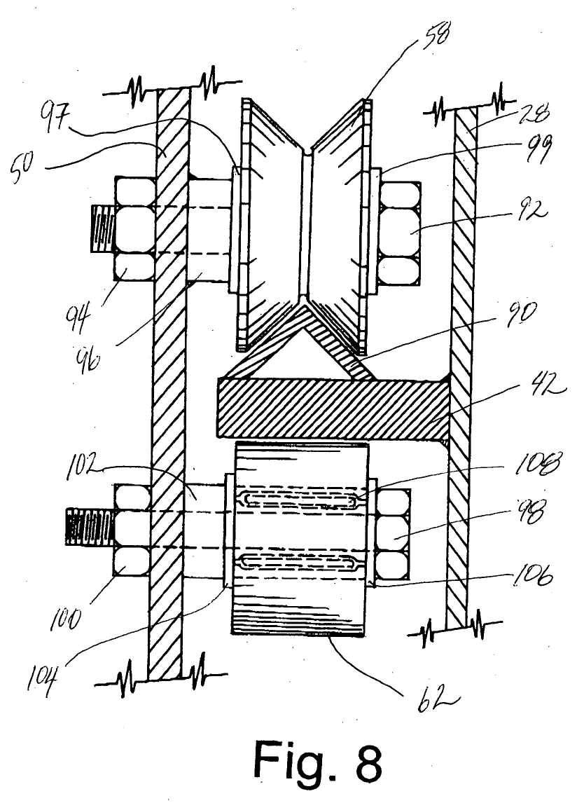

The engagement of the tapered guide roller 58 and the flat guide roller 62 with the guide roller track 42 is shown in FIG. 8. The tapered guide roller 58 is attached to the shield portion 50 of the packer 46 by a first screw 92 and a first bolt 94. Any similar fasteners may be used. A first separator 96 prevents the tapered guide roller 58 from contacting the shield portion 50. Washers 97 and 99 are contiguous with the tapered guide roller 58. The tapered guide roller 58 is rotatable about the first screw 92 and engages the peak 90 of the guide roller track 42.

The flat guide roller 62 is attached to the shield portion 50 of the packer 46 by a second screw 98 and a second bolt 100. A second separator 102 prevents the flat guide roller 62 from contacting the shield portion 50. Washers 104 and 106 are contiguous with the flat guide roller 62. The flat guide roller 62 is rotatable about the second screw 98 and the rotation of the flat guide roller 62 may be enhanced by a cylindrical roller bearing 108.

It will be understood by those skilled in the art that tapered guide roller 60 is attached to the shield portion 50 similarly to the attachment of tapered guide roller 58. It will also be understood by those skilled in the art that flat guide roller 64 is attached to the shield portion similarly to the attachment of flat guide roller 62.

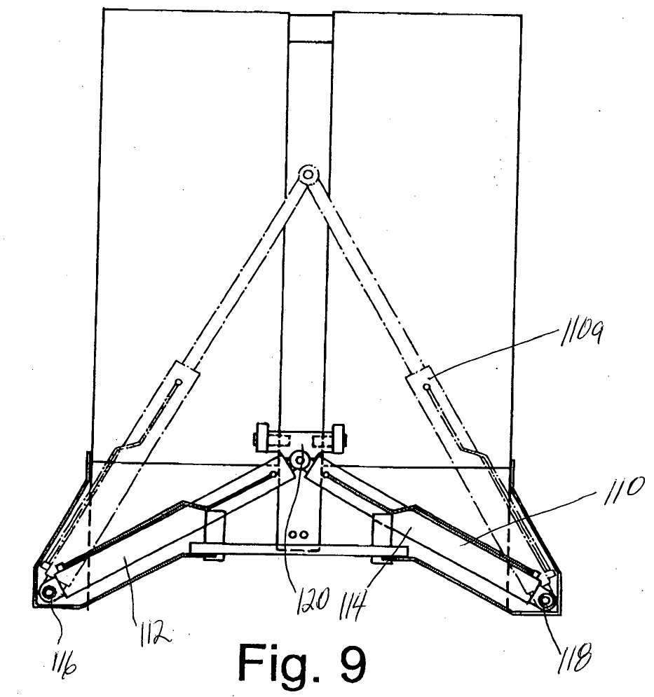

A dual hydraulic press mechanism 110 is attached to the packer 46 as shown in FIG. 9. The dual hydraulic press mechanism 110 is shown in normal outline as it would appear when the packer 46 is in the rest position. The dual hydraulic press mechanism 110a is shown in stippled outline as it would appear when packer 46 is in the deposit position. The dual hydraulic press mechanism 110 has a first hydraulic press 112, a second hydraulic press 114 and brackets 116, 118 and 120. Both the first hydraulic press 112 and the second hydraulic press 114 have a ram and a cylinder. The cylinders of the first hydraulic press 112 and the second hydraulic press 114 are pivotably attached to brackets 116 and 118 respectively near the front wall 26 of the housing 20. The rams of the first hydraulic press 112 and the second hydraulic press 114 are pivotably attached to bracket 120 which is also attached to the packer 46.

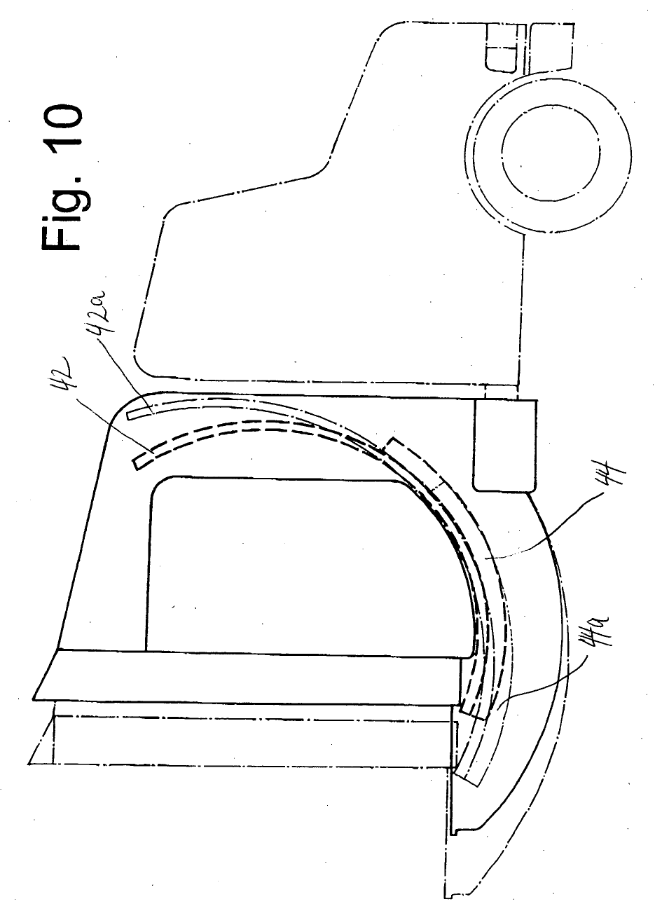

The trajectory of the guide roller track 42 and the trajectory of the guide shoe channel 44 may affect the length of the hopper 30, as seen in FIG. 10. In FIG. 10, guide roller track 42 and thus guide shoe channel 44 are shown as having an alternating trajectory as denoted by reference numbers 42a and 44a. The guide roller track 42 and thus the guide shoe channel 44 having the tighter curvature than the alternative trajectory can allow for the use of a shorter hopper 30 since the packer 46 will require less space. This permits the manufacturer of the vehicle 12 to devote more space in the housing 20 to the storage area 32 or to simply decrease the length of the vehicle 12. Both of these options will move the centre of gravity of the vehicle 12 forward such that more mass is above the front axle of the vehicle 12. However, if the guide roller track 42a and thus the guide shoe channel 44a have less curvature, the hopper 30 will be required to be longer, as shown in stippled lines in FIG. 10, and will thus occupy a greater portion of the housing 20.

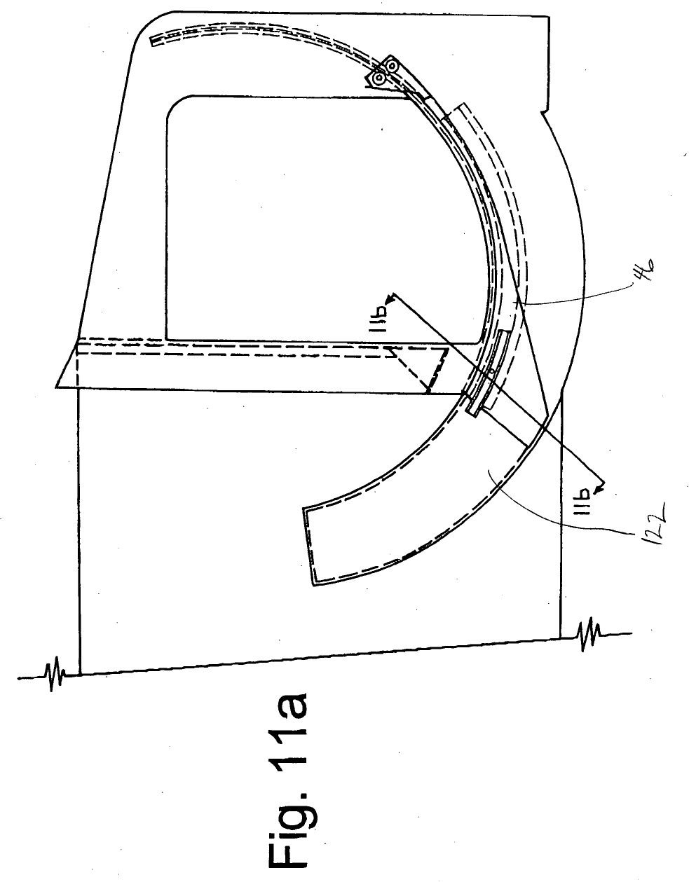

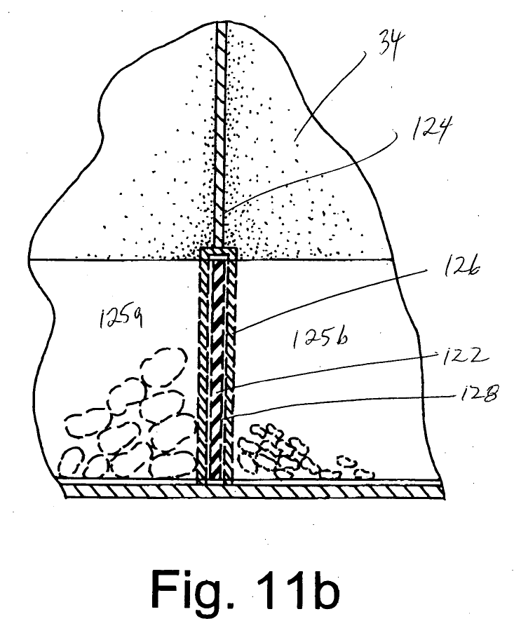

An alternative embodiment of the packer 46 is shown in FIGS. 11a and 11b to accommodate vehicles with multiple compartments within the storage area 32. An extension 122 is integrally attached to the leading face 52 of the packer 46 so as to divide the hopper 36 into multiple compartments. The extension 122 extends to a position within storage area 32 when the packer 46 is in the deposit position. The storage area is divided by a wall 124 into multiple compartments 125a and 125b for storing refuse. In this alternative embodiment, the storage area 32 has an envelope 126 within the wall 124. The envelope 126 defines a slot 128, which is aligned with the extension 122. The slot 128 thus accepts the extension 122 as the packer 46 moves from the rest position to the deposit position, pushing refuse on either side of the extension 122.

In operation, to move refuse received within the hopper 30 to the storage area 32, the dual hydraulic press mechanism 110 is activated so as to extend the rams of the first hydraulic press 112 and the rams of the second hydraulic press 114. As seen in FIGS. 3 and 4, the packer 46 is thus displaced from the rest position through the hopper 30 along a generally arcuate path to the deposit position.

As the packer 46 advances through the hopper 10, the bottom edge of the blade portion 48 remains flush with the floor portion 24 such that refuse across the width of the hopper 30 is collected against the leading face 52 of the packer 46. As the packer 46 displaces the refuse from the hopper 30 to the storage area 32, the shield portion 50 prevents refuse from contacting the dual hydraulic press mechanism 110. As the first hydraulic press 112 and the second hydraulic press 114 extend such that the packer 46 moves toward the deposit position, the blade portion 48 of the packer 46 is displaced beneath the divider 34 into the storage area 32. Refuse is deposited in storage area 32 and the rams of first hydraulic press 112 and second hydraulic press 114 retract, such that the packer 46 returns to the rest position.

As the packer 46 moves between the rest position and the deposit position in the hopper 30, the member 68 and thus the guide shoe 54 rotate about the pin 70 within the guide shoe channel 44. It will be understood by one skilled in the art that the guide shoe 56 moves similarly within the guide shoe channel attached to the second side wall of the housing (not shown). The guide shoes 54 and 56 bear the vertical load of the packer 46 and thus govern its path according the position of the guide shoe channel 44 and its counterpart (not shown). The rotation of the guide shoes 54 and 56 permits even load distribution upon the top faces and the bottom faces of the guide shoes 54 and 56 as the packer 46 is displaced upon the trajectory of the guide shoe channel 44 and the guide shoe channel attached to the second side wall of the housing (not shown).

During the movement of the packer 46 from the rest position to the deposit position, the tapered guide roller 58 rotates and remains engaged with the peak 90 of the guide roller track 42. The flat guide roller 62 remains engaged with the guide roller track 42 as the packer 46 is displaced through the hopper 30. It will be understood by persons skilled in the art that the tapered guide roller 60 and the flat guide roller 64 are similarly engaged with the guide roller track attached to the second side of the housing 20. The tapered guide rollers 58 and 60 and the flat guide rollers 62 and 64 thus maintain the lateral position of the shield portion 50 as the packer 46 is displaced through the hopper 10.

Any lateral movement of the packer 46, which may be caused by the non-uniform density of refuse deposited into the hopper 30, is limited by the proximity of the packer 46 to the first side wall 28 and the second side wall (not shown). This proximity also prevents the guide shoes 54 and 56 from contacting the first side wall 28 and the second side wall (not shown). The lateral movement of the packer 46 within the hopper 30 is also limited by the engagement of the cavity 66 upon the floor portion 24 of the housing 20.

In the further embodiment of the invention shown in FIGS. 11a and 11b, different types of refuse may be added to the separate compartments of the hopper 30 created by the extension 122. When dual hydraulic press mechanism 110 is activated to displace the packer 46 along an generally arcuate path from the rest position to the deposit position, the extension 122 also follows a generally arcuate path. The extension 122 is received by the envelope 126 when the packer 46 moves into the deposit position while the refuse on either side of the extension 122 is being deposited into separate compartments 125a and 125b within the storage area 32 created by the wall 124.

Numerous modifications may be made to the embodiments as described above without departing from the scope of the invention, which is defined by the claims.

Thus, it is apparent that there has been provided in accordance with the invention a NON-LINEAR RECIPROCATING PACKING MECHANISM FOR REFUSE COLLECTION VEHICLE that fully satisfies the objects, aims and advantages set forth above. While the invention has been described in conjunction with specific embodiments thereof, it is evident that many alternatives, modifications and variations will be apparent to those skilled in the art in light of the foregoing description. Accordingly, it is intended to embrace all such alternatives, modifications and variations as fall within the spirit and broad scope of the invention.

1. A refuse collection system for use in combination with a transport vehicle, said system comprising:
a housing having a collection hopper at a first end, a storage area at a second end, the collection hopper having first and second sides;
an opening in at least one of the first side or the second side of the collection hopper and curved channels on each of the first side and the second side of the collection hopper; and
a packer movable frontwards and rearwards within the housing and having a blade portion, the packer being movable along a generally arcuate path defined by the curved channels from a rest position at a first end of the collection hopper to a deposit position at a second end of the collection hopper proximate to the storage area such that the blade portion passes over the collection hopper to sweep refuse from the collection hopper into the storage area.

2. The refuse collection system of claim 1 wherein the housing is attached to a transport vehicle.

3. The refuse collection system of claim 1 further comprising guide shoes attached to the packer and engaged with the channels so as to guide the path of movement of the packer within the channels.

4. The refuse collection system of claim 3 wherein each guide shoe engages a member that is pivotably attached to the packer by an attachment such that each guide shoe pivots about the attachment to the packer.

5. The refuse collection system of claim 1 further comprising curved tracks attached to each of the first side and the second side of the packer.

6. The refuse collection system of claim 5 wherein the radius of curvature of the tracks conforms to the radius of curvature of the channels.

7. The refuse collection system of claim 5 further comprising guide rollers attached to the packer for engagement with the tracks so as to guide the path of movement of the packer.

8. The refuse collection system of claim 7 wherein the tracks are generally triangular in cross-section.

9. The refuse collection system of claim 8 wherein a first set of guide rollers has a tapered edge that engages the tracks.

10. The refuse collection system of claim 9 wherein a bottom edge of the tracks has a flat surface and a second set of guide rollers has a flat edge and engages the bottom edge of the tracks.

11. The refuse collection system of claim 6 wherein the radius of curvature limits the extent of travel of the packer.

12. A refuse collection system for use in combination with a transport vehicle, said system comprising:
a housing having a collection hopper at a first end and a storage area at a second end wherein the collection hopper has first and second sides and the storage area is divided into multiple compartments by a wall;
an opening in at least one of the first side or the second side of the collection hopper;
a packer movable frontwards and rearwards within the housing along a generally arcuate path from a rest position at a first end of the collection hopper to a deposit position at a second end of the collection hopper proximate to the storage area;
a face of the packer for impacting refuse in the collection hopper; and
an extension attached to the face of the packer so as to separate the collection hopper into multiple compartments.

13. The refuse system of claim 12 wherein the housing is attached to a transport vehicle.

14. The refuse collection system of claim 12 wherein the wall defines a slot-like opening for engaging the extension.
